(19) United States
(12) Patent Application Publication
(10) Pub. No.: US 2016/0141577 A1
(43) Pub. Date: May 19, 2016

(54) Energy Storage Device with An Encapsulated Electrode

(71) Applicant: Schlumberger Technology Corporation, Sugar land, TX (US)

(72) Inventors: Rogerio Tadeu Ramos, Eastleigh (GB); Christine Ruth Jarvis, Discot (GB); Vladimir Hernandez Solis, Cheltenham (GB)

(21) Appl. No.: 14/548,225

(22) Filed: Nov. 19, 2014

(51) Int. Cl. H01M 2/16; E21B 41/00; H01M 6/16

(52) U.S. Cl. CPC H01M 2/1673; H01M 6/164; E21B 41/0085; H01M 2300/0028

(57) ABSTRACT

Aspects of the disclosure can relate to an energy storage device including at least two electrodes (e.g., an anode and a cathode). At least one of the two electrodes can be formed from lithium or a lithium alloy. The energy storage device can also include an electrolyte solution in contact with the two electrodes and a separator with a melting point higher than a melting point of lithium. The separator can define a boundary between the two electrodes and encapsulates at least one of the two electrodes. The separator can also be impermeable to molten lithium. Thus, when exposed to a temperature that causes lithium from one or more of the electrodes to melt, the separator can prevent contact between molten lithium from one electrode and the other electrode.

### BACKGROUND

Oil wells are created by drilling a hole into the earth, in some cases using a drilling rig that rotates a drill string (e.g., drill pipe) having a drill bit attached thereto. In other cases, the drilling rig does not rotate the drill bit. For example, the drill bit can be rotated downhole. The drill bit, aided by the weight of pipes (e.g., drill collars) cuts into rock within the earth. Drilling fluid (e.g., mud) is pumped into the drill pipe and exits at the drill bit. The drilling fluid may be used to cool the bit, lift rock cuttings to the surface, at least partially prevent destabilization of the rock in the wellbore, and/or at least partially overcome the pressure of fluids inside the rock so that the fluids do not enter the wellbore. Other equipment can also be used for evaluating formations, fluids, production, other operations, and so forth. Downhole equipment can be powered by remote energy sources that power the equipment via transmission lines (e.g., electrical, optical, mechanical, or hydraulic transmission lines). Downhole equipment can also be powered by local energy sources such as local generators or energy storage devices (e.g., battery packs) coupled with the equipment.

### SUMMARY

Aspects of the disclosure can relate to an energy storage device including at least two electrodes (e.g., an anode and a cathode). At least one of the two electrodes can be formed from lithium or a lithium alloy. The energy storage device can also include an electrolyte solution in contact with the two electrodes and a separator with a melting point higher than a melting point of lithium. The separator can define a boundary between the two electrodes and encapsulates at least one of the two electrodes. The separator can also be impermeable to molten lithium. Thus, when exposed to a temperature that causes lithium from one or more of the electrodes to melt, the separator can prevent contact between molten lithium from one electrode and the other electrode.

Other aspects of the disclosure can relate to a method for providing an energy storage device with at least one encapsulated electrode. The method includes provisioning two electrodes. At least one of the two electrodes can include lithium or a lithium alloy. At least one of the two electrodes can be encapsulated with a separator having a melting point higher than a melting point of lithium and being impermeable to molten lithium. Thus, the separator can define a boundary between the two electrodes. The method can also include provisioning two electrical leads. Each of the two electrical leads can be placed in contact with a respective one of the two electrodes. At least one of the two electrical leads can extend from an encapsulated one of the two electrodes through the separator via a tightly fitting through hole of the separator such that molten lithium cannot leak into or out of the separator from around the electrical lead. An electrolyte solution can be provided in contact with the two electrodes. The two electrodes and the electrolyte solution can also be contained in a vessel including ports for connecting the two electrical leads with respective electrical leads of an external device.

Also, aspects of the disclosure can relate to a system including downhole equipment and an energy storage device coupled with the downhole equipment to power the downhole equipment. The energy storage device can include two electrodes and an electrolyte solution in contact with the two electrodes. At least one of the two electrodes can include lithium or a lithium alloy. The energy storage device can also include a separator with a melting point higher than a melting point of lithium. The separator can be impermeable to molten lithium and can encapsulate at least one of the two electrodes such that it defines a boundary between the two electrodes. The energy storage device can also include two electrical leads. Each of the two electrical leads can be set in contact with a respective one of the two electrodes. At least one of the two electrical leads can be extended from an encapsulated one of the two electrodes through the separator via a tightly fitting through hole of the separator such that molten lithium cannot leak into or out of the separator from around the electrical lead. The energy storage device can also include a vessel containing the two electrodes and the electrolyte solution. The vessel can include ports for connecting the two electrical leads with respective electrical leads of the downhole equipment.

This summary is provided to introduce a selection of concepts that are further described below in the detailed description. This summary is not intended to identify key or essential features of the claimed subject matter, nor is it intended to be used as an aid in limiting the scope of the claimed subject matter.

### FIGURES

Embodiments of an energy storage device with an encapsulated electrode are described with reference to the following figures. The same numbers are used throughout the figures to reference like features and components.

FIG. 1 illustrates an example system in which embodiments of an energy storage device with an encapsulated electrode can be implemented;

FIG. 2 illustrates various components of an example device that can implement embodiments of an energy storage device with an encapsulated electrode;

FIG. 3 illustrates various components of an example device that can implement embodiments of an energy storage device with an encapsulated electrode;

FIG. 4 illustrates various components of an example device that can implement embodiments of an energy storage device with an encapsulated electrode;

FIG. 5 illustrates various components of an example device that can implement embodiments of an energy storage device with an encapsulated electrode;

FIG. 6 illustrates various components of an example device that can implement embodiments of an energy storage device with an encapsulated electrode;

FIG. 7 illustrates various components of an example device that can implement embodiments of an energy storage device with an encapsulated electrode;

FIG. 8 illustrates various components of an example device that can implement embodiments of an energy storage device with an encapsulated electrode;

FIG. 9 illustrates various components of an example device that can implement embodiments of an energy storage device with an encapsulated electrode;

FIG. 10 illustrates various components of an example device that can implement embodiments of an energy storage device with an encapsulated electrode;

FIG. 11 illustrates various components of an example device that can implement embodiments of an energy storage device with an encapsulated electrode;

FIG. 12 illustrates various components of an example device that can implement embodiments of an energy storage device with an encapsulated electrode; and

FIG. 13 illustrates example method(s) for providing an energy storage device with an encapsulated electrode in accordance with one or more embodiments.

### DETAILED DESCRIPTION

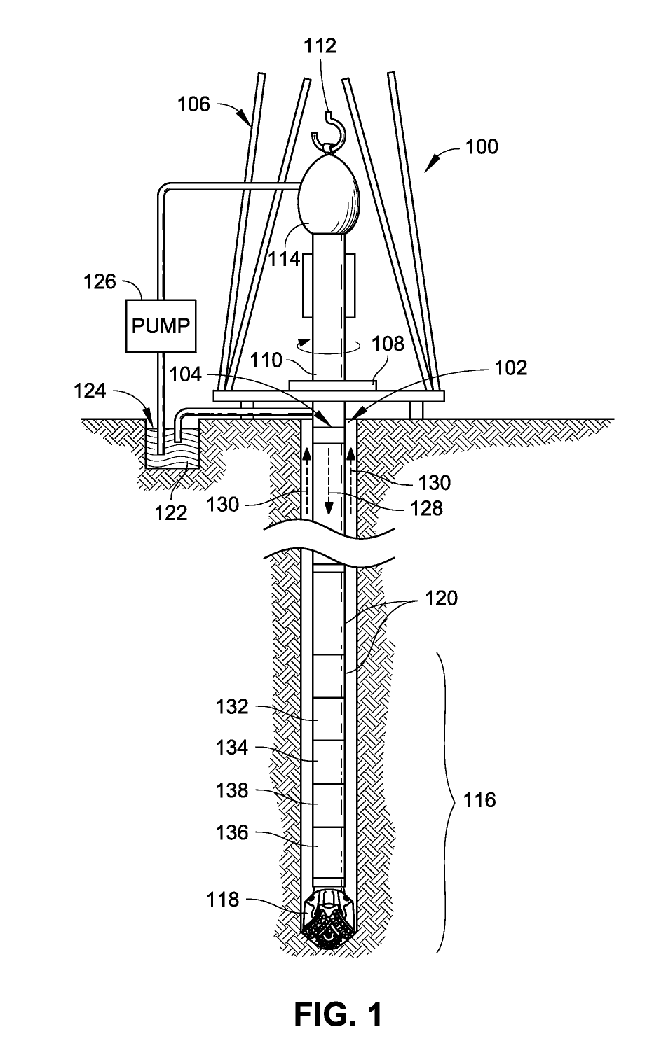

FIG. 1 depicts a wellsite system 100 in accordance with one or more embodiments of the present disclosure. The wellsite can be onshore or offshore. A borehole 102 is formed in subsurface formations by directional drilling. A drill string 104 extends from a drill rig 106 and is suspended within the borehole 102. In some embodiments, the wellsite system 100 implements directional drilling using a rotary steerable system (RSS). For instance, the drill string 104 is rotated from the surface, and down hole devices move the end of the drill string 104 in a desired direction. The drill rig 106 includes a platform and derrick assembly positioned over the borehole 102. In some embodiments, the drill rig 106 includes a rotary table 108, kelly 110, hook 112, rotary swivel 114, and so forth. For example, the drill string 104 is rotated by the rotary table 108, which engages the kelly 110 at the upper end of the drill string 104. The drill string 104 is suspended from the hook 112 using the rotary swivel 114, which permits rotation of the drill string 104 relative to the hook 112. However, this configuration is provided by way of example and is not meant to limit the present disclosure. For instance, in other embodiments a top drive system is used.

A bottom hole assembly (BHA) 116 is suspended at the end of the drill string 104. The bottom hole assembly 116 includes a drill bit 118 at its lower end. In embodiments of the disclosure, the drill string 104 includes a number of drill pipes 120 that extend the bottom hole assembly 116 and the drill bit 118 into subterranean formations. Drilling fluid (e.g., mud) 122 is stored in a tank and/or a pit 124 formed at the wellsite. The drilling fluid can be water-based, oil-based, and so on. A pump 126 displaces the drilling fluid 122 to an interior passage of the drill string 104 via, for example, a port in the rotary swivel 114, causing the drilling fluid 122 to flow downwardly through the drill string 104 as indicated by directional arrow 128. The drilling fluid 122 exits the drill string 104 via ports (e.g., courses, nozzles) in the drill bit 118, and then circulates upwardly through the annulus region between the outside of the drill string 104 and the wall of the borehole 102, as indicated by directional arrows 130. In this manner, the drilling fluid 122 cools and lubricates the drill bit 118 and carries drill cuttings generated by the drill bit 118 up to the surface (e.g., as the drilling fluid 122 is returned to the pit 124 for recirculation).

In some embodiments, the bottom hole assembly 116 includes a logging-while-drilling (LWD) module 132, a measuring-while-drilling (MWD) module 134, a rotary steerable system 136, a motor, and so forth (e.g., in addition to the drill bit 118). The logging-while-drilling module 132 can be housed in a drill collar and can contain one or a number of logging tools. It should also be noted that more than one LWD module and/or MWD module can be employed (e.g. as represented by another logging-while-drilling module 138). In embodiments of the disclosure, the logging-while drilling modules 132 and/or 138 include capabilities for measuring, processing, and storing information, as well as for communicating with surface equipment, and so forth.

The measuring-while-drilling module 134 can also be housed in a drill collar, and can contain one or more devices for measuring characteristics of the drill string 104 and drill bit 118. The measuring-while-drilling module 134 can also include components for generating electrical power for the down hole equipment. This can include a mud turbine generator (also referred to as a “mud motor”) powered by the flow of the drilling fluid 122. However, this configuration is provided by way of example and is not meant to limit the present disclosure. In other embodiments, other power and/or battery systems can be employed. The measuring-while-drilling module 134 can include one or more of the following measuring devices: a weight-on-bit measuring device, a torque measuring device, a vibration measuring device, a shock measuring device, a stick slip measuring device, a direction measuring device, an inclination measuring device, and so on.

In embodiments of the disclosure, the wellsite system 100 is used with controlled steering or directional drilling. For example, the rotary steerable system 136 is used for directional drilling. As used herein, the term “directional drilling” describes intentional deviation of the wellbore from the path it would naturally take. Thus, directional drilling refers to steering the drill string 104 so that it travels in a desired direction. In some embodiments, directional drilling is used for offshore drilling (e.g., where multiple wells are drilled from a single platform). In other embodiments, directional drilling enables horizontal drilling through a reservoir, which enables a longer length of the wellbore to traverse the reservoir, increasing the production rate from the well. Further, directional drilling may be used in vertical drilling operations. For example, the drill bit 118 may veer off of a planned drilling trajectory because of the unpredictable nature of the formations being penetrated or the varying forces that the drill bit 118 experiences. When such deviation occurs, the wellsite system 100 may be used to guide the drill bit 118 back on course.

Drill assemblies can be used with, for example, a wellsite system (e.g., the wellsite system 100 described with reference to FIG. 1). For instance, a drill assembly can comprise a bottom hole assembly suspended at the end of a drill string (e.g., in the manner of the bottom hole assembly 116 suspended from the drill string 104 depicted in FIG. 1). In some embodiments, a drill assembly is implemented using a drill bit. However, this configuration is provided by way of example and is not meant to limit the present disclosure. In other embodiments, different working implement configurations are used. Further, use of drill assemblies in accordance with the present disclosure is not limited to wellsite systems described herein. Drill assemblies can be used in other various cutting and/or crushing applications, including earth boring applications employing rock scraping, crushing, cutting, and so forth.

A drill assembly includes a body for receiving a flow of drilling fluid. The body comprises one or more crushing and/or cutting implements, such as conical cutters and/or bit cones having spiked teeth (e.g., in the manner of a roller-cone bit). In this configuration, as the drill string is rotated, the bit cones roll along the bottom of the borehole in a circular motion. As they roll, new teeth come in contact with the bottom of the borehole, crushing the rock immediately below and around the bit tooth. As the cone continues to roll, the tooth then lifts off the bottom of the hole and a high-velocity drilling fluid jet strikes the crushed rock chips to remove them from the bottom of the borehole and up the annulus. As this occurs, another tooth makes contact with the bottom of the borehole and creates new rock chips. In this manner, the process of chipping the rock and removing the small rock chips with the fluid jets is continuous. The teeth intermesh on the cones, which helps clean the cones and enables larger teeth to be used. A drill assembly comprising a conical cutter can be implemented as a steel milled-tooth bit, a carbide insert bit, and so forth. However, roller-cone bits are provided by way of example and are not meant to limit the present disclosure. In other embodiments, a drill assembly is arranged differently. For example, the body of the bit comprises one or more polycrystalline diamond compact (PDC) cutters that shear rock with a continuous scraping motion.

In embodiments of the disclosure, the body of a drill assembly can define one or more nozzles that allow the drilling fluid to exit the body (e.g., proximate to the crushing and/or cutting implements). The nozzles allow drilling fluid pumped through, for example, a drill string to exit the body. For example, drilling fluid can be furnished to an interior passage of the drill string by the pump and flow downwardly through the drill string to a drill bit of the bottom hole assembly, which can be implemented using, for example, a drill assembly. Drilling fluid then exits the drill string via nozzles in the drill bit, and circulates upwardly through the annulus region between the outside of the drill string and the wall of the borehole. In this manner, rock cuttings can be lifted to the surface, destabilization of rock in the wellbore can be at least partially prevented, the pressure of fluids inside the rock can be at least partially overcome so that the fluids do not enter the wellbore, and so forth.

Modern oil and gas exploration increasingly uses electronic devices in the borehole to provide measurements, and for control and operational optimization. Although a wellsite drilling system 100 is described herein, those skilled in the art will appreciated that any wellsite system can include downhole electronic equipment (e.g., sensors, actuators, communication devices, or the like). When operating electronics as part of a drill string and/or other downhole equipment and/or strings (e.g., for well testing, well simulation, well monitoring, formation evaluation, etc.), available power in the borehole may be limited near a bottom hole assembly. In some cases, electrical power can be generated by turbines while fluids are pumped into and/or out of a well, but this technique may not be efficient when there is little or no movement of fluids. Batteries can also be installed in electronic equipment to provide electrical power in a borehole, but batteries have a finite energy storage capacity, which limits the amount of time the equipment can be operated. In some cases, larger batteries may be used, but the amount of space available in the borehole is also finite, limiting the size of such batteries. In other cases, higher power density batteries may be used, but such batteries may be more prone to failure (e.g., in the high temperature operating conditions present downhole). The availability of energy to various sensors, actuators, communication modules (e.g., receivers or transmitters) and other downhole equipment in oil wells is a difficult issue due to the harsh environment in terms of temperature and vibration. High temperatures (e.g., 200° C. and above) can be encountered down hole, but equipment may also operate at room temperature. Sometimes a wide range of temperatures is encountered in operation.

As described herein, batteries can use lithium (Li) or lithium alloy in at least one of the electrodes (i.e., in the anode, the cathode, or both). Yet, it has been found that the maximum operating temperature of a battery cell can be limited by the melting point of lithium (˜180° C.). Alloys, such as lithium magnesium alloys, can be used in an electrode to increase the effective melting point of the electrode (e.g., the temperature at which at least a portion of the electrode begins to melt). However, it has been found that at high temperatures molten lithium can seep through the alloy formation and enter in contact with the other electrode, thus providing a short circuit that can cause the battery to fail. Additionally, it has been found that use of other metals with lithium to form alloys exhibiting higher melting points can result an increase in overall battery size to achieve adequate storage capacity.

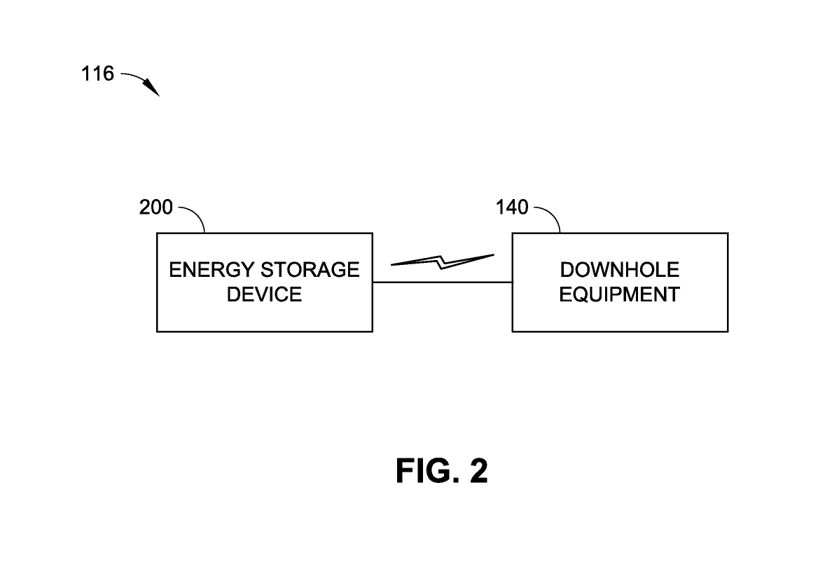

As shown in FIG. 2, a bottom hole assembly 116 can include downhole equipment 140 coupled with an energy storage device 200 that powers the downhole equipment 140. Downhole equipment 140 powered by the energy storage device can include a sensor, an actuator (e.g., motor, servo, or switch), a transmitter, a receiver, a controller, or the like. For example, the downhole equipment 140 can include one or more components of the logging-while-drilling (LWD) module 132, the measuring-while-drilling (MWD) module 134, the rotary steerable system 136, and so forth. The energy storage device 200 can be directly coupled (e.g., via a wired connection) to the downhole equipment 140. The energy storage device 200 can also be optically or electromagnetically coupled with the downhole equipment 140.

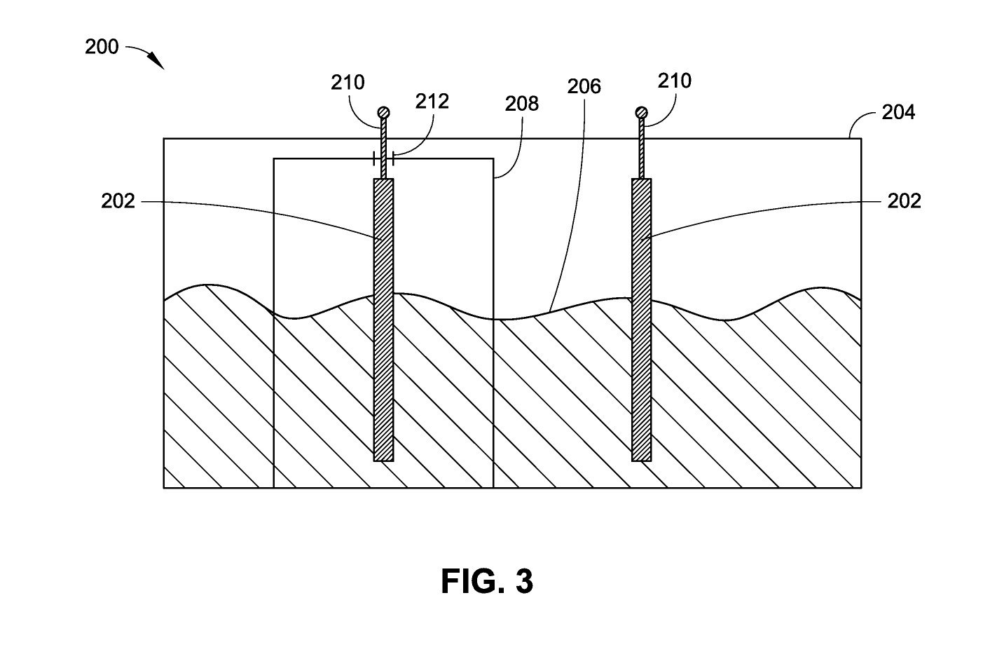

FIGS. 3 through 12 illustrate embodiments of an energy storage device 200 (e.g., a battery) that can be used to power down hole equipment 140, as discussed above, or in other high temperature applications (e.g., applications where temperatures exceeding the melting point of lithium are encountered). For example, the energy storage device 200 can be used to power equipment (e.g., pressure sensors, emission sensors, heat sensors, alarms, safety/process controllers, communication devices, or the like) associated with monitoring/control of volatile substances, power plant operations/safety control, fire rescue, harsh natural environments (e.g., volcanic formations), and so forth. As shown in FIG. 3, the energy storage device 200 includes at least two electrodes 202 (e.g., an anode and a cathode) and an electrolyte solution 206 in contact with the two electrodes 202. The electrolyte solution 206 can be a liquid, a paste, or a gel. For example, the electrolyte solution 206 can include a salt (e.g., a lithium salt such as LiPF₆, LiBF₄, LiCIO₄, LiN(CF₃SO₂)₂, or the like) in a solvent (e.g., ethylene carbonate, dimethyl carbonate, diethyl carbonate, propylene carbonate, ionic liquids, or the like). The energy storage device 200 can also include a vessel 204 containing the two electrodes 202 and the electrolyte solution 206.

At least one of the two electrodes 202 includes lithium or a lithium alloy. In some embodiments, at least one of the two electrodes can be formed from lithium or an alloy with at least 60% lithium content. For example, the alloy can include about 60% to about 100% lithium content. By way of further example, the alloy can include about 60%, 65%, 70%, 75%, 80%, 85%, 90%, 95%, or 100% lithium content. In this regard, higher lithium content can result in higher storage capacity and/or reduced overall size of the energy storage device 200.

The energy storage device 200 also includes a separator 208 with a melting point higher than a melting point of lithium. The separator 208 is also impermeable to molten lithium. For example, the separator 208 can be formed from a polymer, a polyimide, fiberglass, a ceramic material, or the like. Although the separator 208 is impermeable to molten lithium, the separator 208 is permeable to electrolytes from the electrolyte solution 206 to allow electrolyte flow between the electrodes 202. The separator 208 encapsulates at least one of the two electrodes 202 and defines a boundary between the two electrodes 206. At high temperatures (e.g., above a melting point of lithium), the separator 208 contains molten lithium from an encapsulated one of the two electrodes 202 and/or protects the encapsulated one of the two electrodes 202 from molten lithium of another one of the two electrodes 202. Thus, the separator 208 prevents the electrodes 202 from short circuiting with one another.

The energy storage device 200 can also include two electrical leads 210. Each of the two electrical leads 210 is in contact with a respective one of the two electrodes 202. At least one of the two electrical leads 210 extends from an encapsulated one of the two electrodes 202 through the separator 208 via a tightly fitting through hole 212 (e.g., “tightly fitting” such that molten lithium cannot leak into or out of the separator 208 from around the electrical lead 210). The through hole 212 may be lined with a gasket and/or tightly formed around the electrical lead 210 to avoid seepage of molten lithium into or out of the encapsulated one of the two electrodes 202. The vessel 204 can include ports (e.g., through holes or interfacing connectors/leads) for connecting the two electrical leads 210 with respective electrical leads of the downhole equipment 140 or any other device powered by the energy storage device 200.

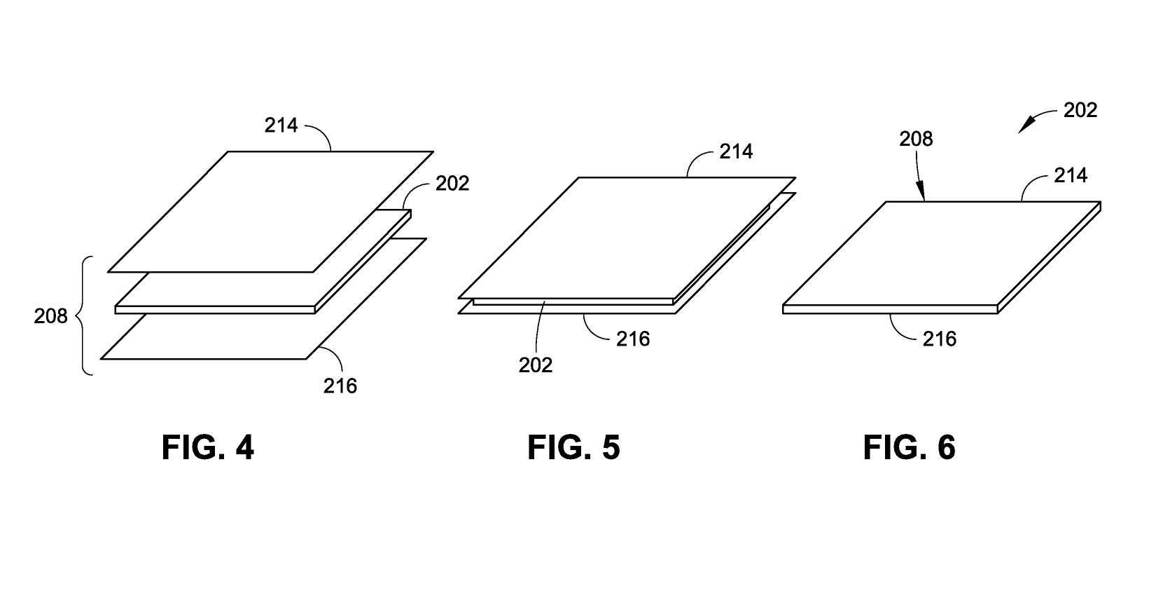

As shown in FIGS. 4 through 6, the separator 208 can comprise at least a first separator sheet 214 and a second separator sheet 216. For example, FIGS. 4 and 5 show embodiments where the first separator sheet 214 is adjacent to a first surface of an encapsulated one of the two electrodes 202, and the second separator sheet 216 is adjacent to a second surface of the encapsulated one of the two electrodes 202. The first separator sheet 214 and the second separator sheet 216 can be pressed together overlapping at edges that define a perimeter of the encapsulated one of the two electrodes 202 (e.g., as shown in FIG. 5) and sealed together at the edges to encapsulate the electrode 202 (e.g., as shown in FIG. 6). Portions of the separator 208 can be sealed together by contact sealing, pressure sealing, tightly folding or winding the separator material, thermal sealing, glue sealing, sewing, or by any other sealing process that sufficiently prevents molten lithium from leaking out of the encapsulated electrode 202.

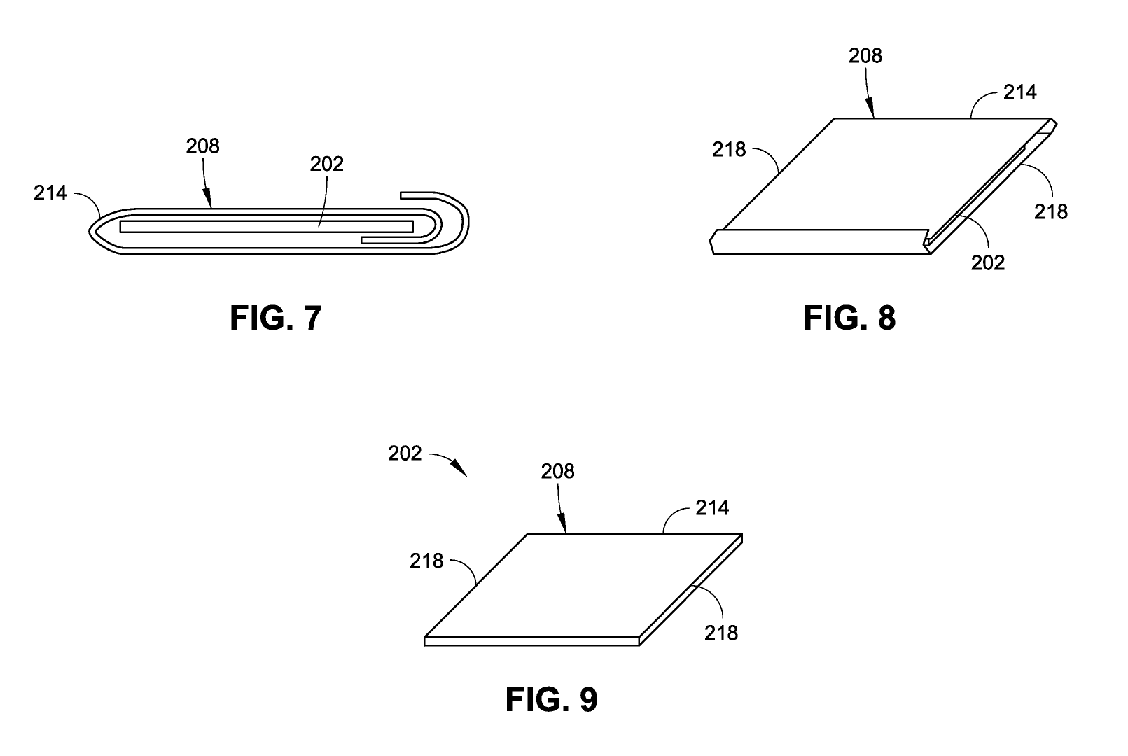

The separator 208 can be formed from a flexible separator material (e.g., a polymer or polyimide). As shown in FIGS. 7 through 9, where the separator 208 comprises one or more sheets 214 of a flexible separator material, the electrode 202 can be encapsulated with a separator sheet 214 wrapped around the electrode 202. For example, the separator sheet covers a first surface and a second surface of the electrode 202 (e.g., as shown in FIGS. 7 and 8) and is folded over at least one edge of the electrode 202. The separator sheet 214 can then be sealed together at two or more edges 218 to encapsulate the electrode 202 (e.g., as shown in FIG. 9).

As discussed above, an electrical lead 210 can be placed in contact with the encapsulated electrode 202 via a tightly fitting through hole 212 formed in the separator 208. In some embodiments, the electrical lead 210 is coupled to the electrode 202 prior to encapsulation with the separator 208 (i.e., before the edges are sealed off) so that the separator material is tightly fit around the electrical lead 210 during a sealing process to form the tightly fitting through hole 212. In other embodiments, the through hole 212 is formed in the separator 208 after the electrode 202 is encapsulated. The through hole 212 can be lined with a gasket or resin that tightly fits the through hole 212 around the electrical lead 210 so that molten lithium cannot seep out of the separator 208 from any openings around the electrical lead 210.

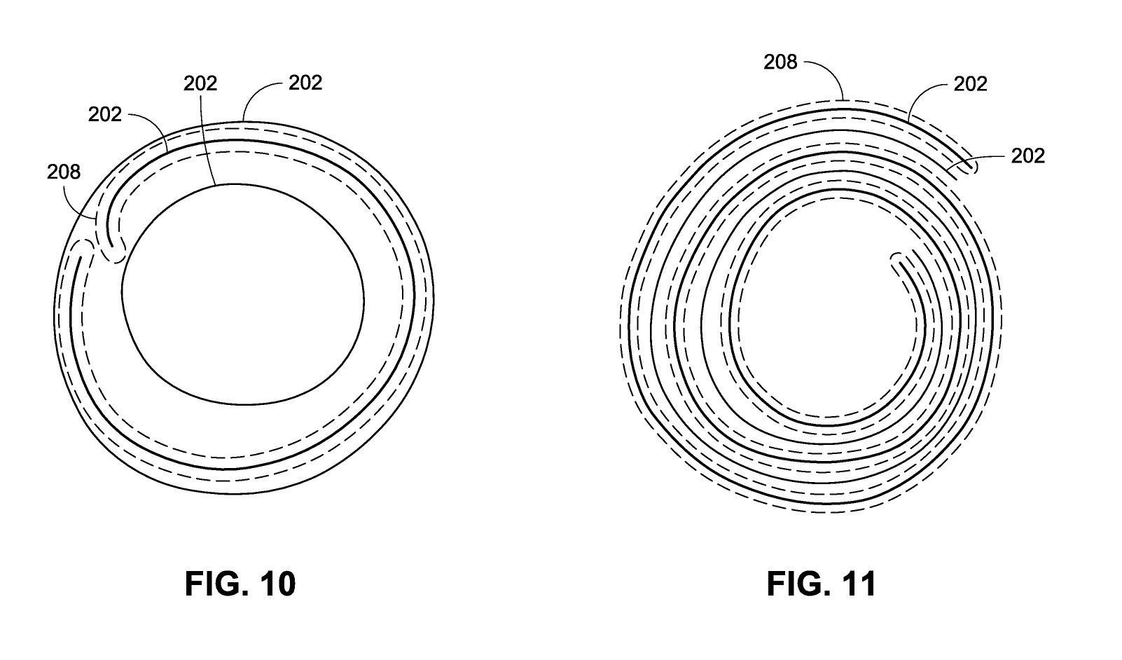

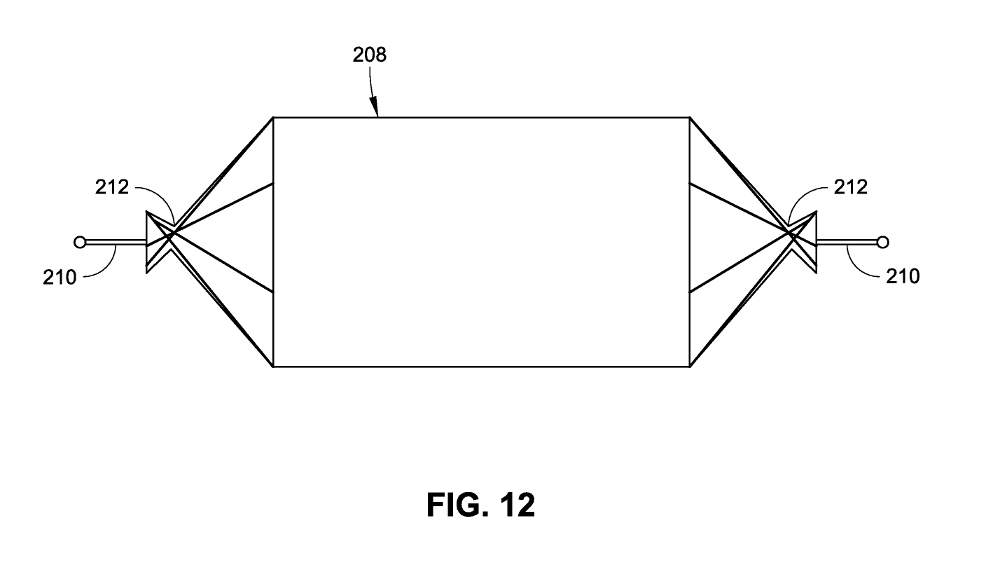

As shown in FIGS. 10 and 11, respectively, the electrodes 202 can be arranged in a bobbin or jellyroll configuration. In a bobbin configuration (e.g., as shown in FIG. 10), the encapsulated one of the two electrodes 202 can be rolled into a cylindrical structure and placed around the other electrode 202, which is also rolled into a cylindrical structure, or vice versa. In some embodiments, the bobbin structure further includes a third (outermost) electrode 202 that is the same type as the innermost electrode 202. In general, two or more electrodes 202 can be arranged as shown in FIG. 10 as follows: anode, cathode, anode, and so on; or cathode, anode, cathode, and so on. In a jellyroll configuration (e.g., as shown in FIG. 11) the encapsulated one of the two electrodes 202 and the other electrode 202 can be spiraled around one another (i.e., forming at least an inner spiral and an outer spiral).

Where a bobbin or jellyroll configuration is implemented, the separator 208 may form an outer layer that wraps around both of the electrodes 202 (e.g., as shown in FIG. 12). Further, one or more separator sheets of the separator 208 may extend beyond two outer (e.g., side-facing) edges of the encapsulated one of the two electrodes 202. The extended portions of the one or more separator sheets can be wound together to seal (i.e., encapsulate) the encapsulated one of the two electrodes 202. One or more through holes 212 for connecting the electrical leads 210 to the electrodes 202 can be formed at the centers of the wound together portions of the separator 208. In some embodiments, the electrical leads 210 are connected to the electrodes 202 prior to sealing (i.e., winding together) the one or more separator sheets. Thus when wound together, the one or more separator sheets form a tightly fitting through hole 212 around each of the electrical leads 210.

Bobbin or jellyroll configurations can be used to prepare the electrodes 202 for insertion in the vessel 204, which can include a cylindrical canister. However, the vessel 204 and the electrode configuration are not limited to cylindrical formation. Those skilled in the art will appreciate that the electrodes 202 can be arranged in rectangular and other geometric formations as well. Some of these formations may include aspects of the bobbin or jellyroll configurations described above. Some formations may simply include a first electrode 202 placed in parallel with a second electrode 202. Various arrangements can be implemented without departing from the scope of the energy storage device 200 described herein.

A system implementing a drill assembly or any other downhole equipment 140, including one or more of its components, can operate under computer control and can be powered by a local storage device (e.g., a battery or battery pack), such as the energy storage device 200. For example, a processor can be included with or in a system to control the components and functions of systems described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The drill assembly can be coupled with a controller including a processor, a memory, and a communications interface. The processor provides processing functionality for the controller and can include any number of processors, micro-controllers, or other processing systems, and resident or external memory for storing data and other information accessed or generated by the controller. The processor can execute one or more software programs that implement techniques described herein. The processor is not limited by the materials from which it is formed or the processing mechanisms employed therein and, as such, can be implemented via semiconductor(s) and/or transistors (e.g., using electronic integrated circuit (IC) components), and so forth.

The memory is an example of tangible, computer-readable storage medium that provides storage functionality to store various data associated with operation of the controller, such as software programs and/or code segments, or other data to instruct the processor, and possibly other components of the controller, to perform the functionality described herein. Thus, the memory can store data, such as a program of instructions for operating the system (including its components), and so forth. It should be noted that while a single memory is described, a wide variety of types and combinations of memory (e.g., tangible, non-transitory memory) can be employed. The memory can be integral with the processor, can comprise stand-alone memory, or can be a combination of both. The memory can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth.

The communications interface is operatively configured to communicate with components of the system. For example, the communications interface can be configured to transmit data for storage in the system, retrieve data from storage in the system, and so forth. The communications interface is also communicatively coupled with the processor to facilitate data transfer between components of the system and the processor (e.g., for communicating inputs to the processor received from a device communicatively coupled with the controller). It should be noted that while the communications interface is described as a component of a controller, one or more components of the communications interface can be implemented as external components communicatively coupled to the system via a wired and/or wireless connection. The system can also comprise and/or connect to one or more input/output (I/O) devices (e.g., via the communications interface), including, but not necessarily limited to: a display, a mouse, a touchpad, a keyboard, and so on.

The communications interface and/or the processor can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example and is not meant to limit the present disclosure. Further, the communications interface can be configured to communicate with a single network or multiple networks across different access points.

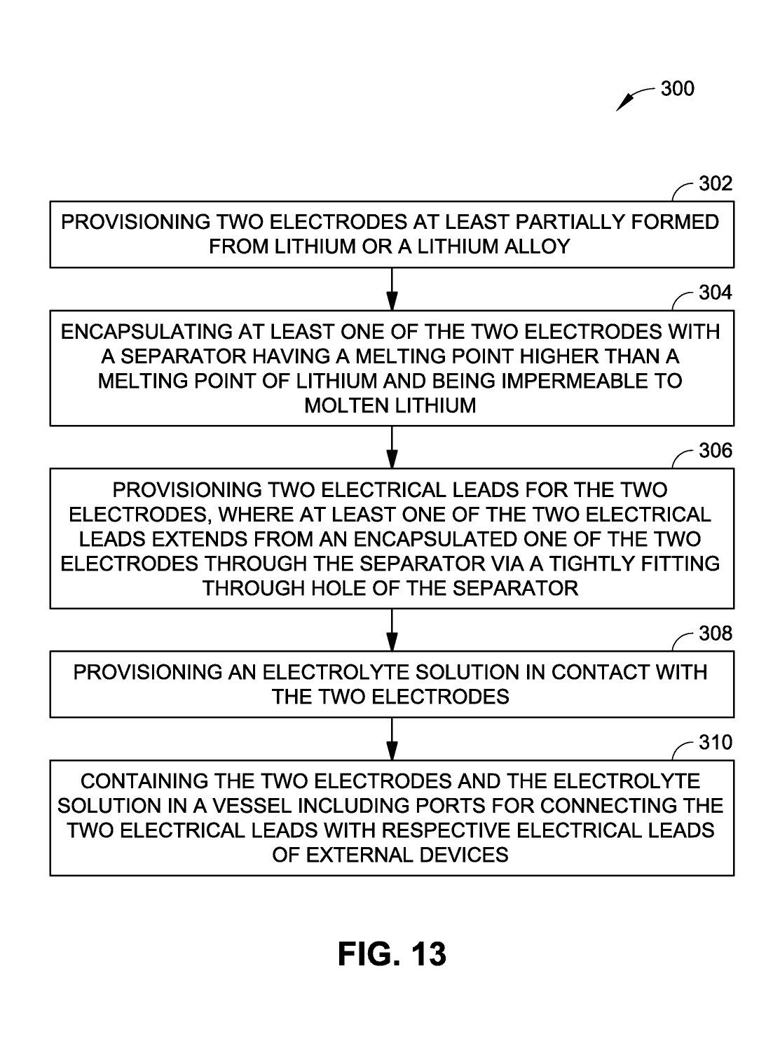

Referring now to FIG. 13, a procedure 300 for forming an energy storage device (e.g., energy storage device 200) is described in accordance with embodiments of the disclosure. At block 302, two electrodes (e.g., electrodes 202) are provided with at least one of the two electrodes including lithium or a lithium alloy. At block 304, at least one of the two electrodes is encapsulated with a separator (e.g., separator 208) having a melting point higher than a melting point of lithium and being impermeable to molten lithium. The separator defines a boundary between the two electrodes and prevents the encapsulated one of the two electrodes from short circuiting with the other electrode when lithium from one of the two electrodes melts at high temperatures. At block 306, two electrical leads (e.g., electrical leads 210) are provided with each of the two electrical leads placed in contact with a respective one of the two electrodes. At least one of the two electrical leads is extended from the encapsulated one of the two electrodes through the separator via a tightly fitting through hole (e.g., through hole 212). At block 308, an electrolyte solution (e.g., electrolyte solution 206) is placed in contact with the two electrodes. At block 310, the electrodes and the electrolyte solution are contained in a vessel (e.g., vessel 204) including ports for connecting the two electrical leads with respective electrical leads of an external device (e.g., downhole equipment 140 or any other equipment).

Although a few example embodiments have been described in detail above, those skilled in the art will readily appreciate that many modifications are possible in the example embodiments without materially departing from an energy storage device with an encapsulated electrode. Features shown in individual embodiments referred to above may be used together in combinations other than those which have been shown and described specifically. Accordingly, any such modification is intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. An energy storage device, comprising:
two electrodes, at least one of the two electrodes including lithium or a lithium alloy;
an electrolyte solution in contact with the two electrodes; and
a separator that encapsulates at least one of the two electrodes and defines a boundary between the two electrodes, the separator having a melting point higher than a melting point of lithium and being impermeable to molten lithium.

2. The energy storage device as recited in claim 1, further comprising:
two electrical leads, each of the two electrical leads in contact with a respective one of the two electrodes, at least one of the two electrical leads extending from an encapsulated one of the two electrodes through the separator via a tightly fitting through hole of the separator.

3. The energy storage device as recited in claim 1, wherein the separator comprises a first separator sheet adjacent to a first surface of an encapsulated one of the two electrodes and a second separator sheet adjacent to a second surface of the encapsulated one of the two electrodes, the first separator sheet and the second separator sheet being sealed together at edges defining a perimeter of the encapsulated one of the two electrodes.

4. The energy storage device as recited in claim 1, wherein the separator comprises a separator sheet wrapped around an encapsulated one of the two electrodes, the separator sheet being folded over at least one edge of the encapsulated one of the two electrodes and sealed together at two or more edges of the encapsulated one of the two electrodes.

5. The energy storage device as recited in claim 1, wherein the separator comprises one or more separator sheets including portions extending beyond two edges of an encapsulated one of the two electrodes, the two edges of the encapsulated one of the two electrodes forming a bobbin or jellyroll arrangement with two respective edges of another one of the two electrodes, the portions extending beyond the two edges of the encapsulated one of the two electrodes being wound together to seal the two edges.

6. The energy storage device as recited in claim 1, wherein the separator is formed from at least one of: a polymer, a polyimide, fiberglass, or a ceramic material.

7. The energy storage device as recited in claim 1, wherein the two electrodes comprise an anode and a cathode.

8. The energy storage device as recited in claim 1, wherein the separator is permeable to electrolytes of the electrolyte solution.

9. A method, comprising:
provisioning two electrodes, at least one of the two electrodes including lithium or a lithium alloy;
encapsulating at least one of the two electrodes with a separator having a melting point higher than a melting point of lithium and being impermeable to molten lithium, the separator defining a boundary between the two electrodes;
provisioning two electrical leads, each of the two electrical leads in contact with a respective one of the two electrodes, at least one of the two electrical leads extending from an encapsulated one of the two electrodes through the separator via a tightly fitting through hole of the separator;
provisioning an electrolyte solution in contact with the two electrodes; and
containing the two electrodes and the electrolyte solution in a vessel including ports for connecting the two electrical leads with respective electrical leads of an external device.

10. The method as recited in claim 9, wherein encapsulating at least one of the two electrodes with the separator includes:
provisioning a first separator sheet adjacent to a first surface of the encapsulated one of the two electrodes;
provisioning a second separator sheet adjacent to a second surface of the encapsulated one of the two electrodes; and
sealing the first separator sheet and the second separator sheet together at edges defining a perimeter of the encapsulated one of the two electrodes.

11. The method as recited in claim 9, wherein encapsulating at least one of the two electrodes with the separator includes:
wrapping a separator sheet around the encapsulated one of the two electrodes, the separator sheet being folded over at least one edge of the encapsulated one of the two electrodes; and
sealing portions of the separator sheet together at two or more edges of the encapsulated one of the two electrodes.

12. The method as recited in claim 9, wherein encapsulating at least one of the two electrodes with the separator includes:
covering at least two surfaces of the encapsulated one of the two electrodes with one or more separator sheets including portions extending beyond two edges of the encapsulated one of the two electrodes;
rolling the two edges of the encapsulated one of the two electrodes with two respective edges of another one of the two electrodes to form a bobbin or jellyroll arrangement, and
winding the portions of the one or more separator sheets that extend beyond the two edges of the encapsulated one of the two electrodes together to seal the two edges.

13. The method as recited in claim 9, wherein the separator is formed from at least one of: a polymer, a polyimide, fiberglass, or a ceramic material.

14. The method as recited in claim 9, wherein the two electrodes comprise an anode and a cathode.

15. A system, comprising:
downhole equipment; and
an energy storage device coupled with the downhole equipment to power the downhole equipment, the energy storage device including:
two electrodes, at least one of the two electrodes including lithium or a lithium alloy;
an electrolyte solution in contact with the two electrodes;
a separator that encapsulates at least one of the two electrodes and defines a boundary between the two electrodes, the separator having a melting point higher than a melting point of lithium and being impermeable to molten lithium;
two electrical leads, each of the two electrical leads in contact with a respective one of the two electrodes, at least one of the two electrical leads extending from an encapsulated one of the two electrodes through the separator via a tightly fitting through hole of the separator; and
a vessel containing the two electrodes and the electrolyte solution, the vessel including ports for connecting the two electrical leads with respective electrical leads of the downhole equipment.

16. The system as recited in claim 15, wherein the separator comprises a first separator sheet adjacent to a first surface of an encapsulated one of the two electrodes and a second separator sheet adjacent to a second surface of the encapsulated one of the two electrodes, the first separator sheet and the second separator sheet being sealed together at edges defining a perimeter of the encapsulated one of the two electrodes.

17. The system as recited in claim 15, wherein the separator comprises a separator sheet wrapped around an encapsulated one of the two electrodes, the separator sheet being folded over at least one edge of the encapsulated one of the two electrodes and sealed together at two or more edges of the encapsulated one of the two electrodes.

18. The system as recited in claim 15, wherein the separator comprises one or more separator sheets including portions extending beyond two edges of an encapsulated one of the two electrodes, the two edges of the encapsulated one of the two electrodes forming a bobbin or jellyroll arrangement with two respective edges of another one of the two electrodes, the portions extending beyond the two edges of the encapsulated one of the two electrodes being wound together to seal the two edges.

19. The system as recited in claim 15, wherein the separator is formed from at least one of: a polymer, a polyimide, fiberglass, or a ceramic material.

20. The system as recited in claim 15, wherein the downhole equipment comprises at least one of: a sensor, an electrical motor, a transmitter, a receiver, or a controller.
